(19) United States
(12) Patent Application Publication
(10) Pub. No.: US 2026/0319555 A1
(43) Pub. Date: Oct. 15, 2026

(54) TOOL-LESS DEVICES FOR COMPUTER HARD DRIVES

(71) Applicant: Aivres Systems Inc., San Jose, CA (US)

(72) Inventor: CHING WEN HSIAO, New Taipei City (TW)

(21) Appl. No.: 19/174,537

(22) Filed: Apr. 9, 2025

(51) Int. Cl. G06F 1/18

(52) U.S. Cl. CPC G06F 1/187

(57) ABSTRACT

Devices, apparatus, and methods for managing computer hard drives, e.g., using tool-less devices for assembling and/or disassembling the computer hard drives from computing systems are provided. An example device includes a pressing element having one or more contact surfaces, one or more flexible pins, and one or more sliders. Each slider has a first sliding surface configured to be in contact with a respective contact surface of the pressing element and a second sliding surface configured to be in contact with a respective flexible pin. The pressing element is movable along a first direction to cause each of the one or more sliders to move along a second direction through a contact between the first sliding surface and the respective contact surface of the pressing element to thereby cause the respective flexible pin to move along the first direction by a movement of the second sliding surface.

### BACKGROUND

During a service phase of a computing system (e.g., a server computer), operators might need to replace and change a computer hard drive. In some cases, the computer hard drive is attached to a hard drive handle via screws, which requires tools to disassemble the hard drive handle and the computer hard drive. The operators also need to use tools to assemble the new computer hard drive and the hard drive handle.

### SUMMARY

The present disclosure provides devices, apparatus, and methods for managing computer hard drives, e.g., using tool-less devices for assembling and/or disassembling the computer hard drives from a computing system.

One aspect of the present disclosure features a device. The device includes a pressing element including one or more contact surfaces; one or more flexible pins; and one or more sliders, where each of the one or more sliders has a first sliding surface configured to be in contact with a respective contact surface of the pressing element and a second sliding surface configured to be in contact with a respective flexible pin of the one or more flexible pins, where the pressing element is movable along a first direction to cause each of the one or more sliders to move along a second direction different from the first direction through a contact between the first sliding surface and the respective contact surface of the pressing element to thereby cause the respective flexible pin to move along the first direction by a movement of the second sliding surface.

In some implementations, each of the one or more flexible pins includes a contact structure configured to be in contact with a corresponding second sliding surface of a corresponding slider of the one or more sliders; a flexible structure; and a connection module configured to move through a mounting hole of a computer hard drive and secure the computer hard drive.

In some implementations, the contact structure, the flexible structure, and the connection module are integrated into a single piece to form the flexible pin.

In some implementations, the device further includes a frame configured to hold the pressing element, the one or more sliders, and the one or more flexible pins.

In some implementations, the frame includes a top portion including a curved portion configured to guide a movement of the pressing element; and a bottom portion including one or more first holes, where each of the one or more first holes is configured to guide a movement of a slider of the one or more sliders.

In some implementations, the top portion and the bottom portion of the frame are mounted together by at least one locking screw.

In some implementations, the pressing element is attached to the bottom portion of the frame through a pressing spring, and where the pressing spring is configured to reposition the pressing element along the first direction.

In some implementations, the bottom portion of the frame further includes a blocking element configured to limit a range of the movement of the pressing element along the first direction.

In some implementations, each of the one or more sliders is attached to the bottom portion of the frame through a respective sliding spring, and where the respective sliding spring is configured to reposition the slider along the second direction.

In some implementations, each of the one or more sliders includes a sliding pin that is surrounded by the sliding spring, the sliding pin being adjacent to the second sliding surface of the slider along a third direction perpendicular to the first direction and the second direction, and where the sliding pin is configured to limit a range of a movement of the slider along the second direction.

In some implementations, the flexible pin is attached to the bottom portion of the frame through a flexible spring configured to reposition the flexible pin along the first direction, where the flexible pin is configured to move through a hole of the bottom portion of the frame, and where a size of the contact structure of the flexible pin is greater than a size of the hole of the bottom portion of the frame.

In some implementations, the device further includes a latch attached to the frame by a rotating pin, and where the latch is moveable between an open position and a closed position through a rotation of the rotating pin, and where the latch includes a blocking module configured to prevent the movement of the pressing element when the latch is at the open position and to let the pressing element move when the latch is at the closed position.

In some implementations, the device is configured to be assembled with a computer hard drive and attach the computer hard drive onto a slot of a computer system.

Another aspect of the present disclosure features a method of assembling a device. The method includes attaching one or more flexible pins to a frame; attaching one or more sliders to the frame, where each of the one or more sliders is positioned on top of a corresponding flexible pin of the one or more flexible pins; and attaching a pressing element to the frame, where the pressing element includes one or more contact surfaces, and each of the one or more sliders has a first sliding surface configured to be in contact with a respective contact surface of the pressing element and a second sliding surface configured to be in contact with a respective flexible pin of the one or more flexible pins, and where the pressing element is movable along a first direction to cause each of the one or more sliders to move along a second direction different from the first direction through a contact between the first sliding surface and the respective contact surface of the pressing element to thereby cause the respective flexible pin to move along the first direction.

In some implementations, the one or more flexible pins are attached to the frame by one or more flexible springs, the one or more sliders are attached to the frame by one or more sliding springs, and the pressing element is attached to the frame by a pressing spring.

In some implementations, the method further includes attaching a latch to the frame by a rotating pin, where the latch is moveable between an open position and a closed position through a rotation of the rotating pin, and the latch includes a blocking module configured to prevent a movement of the pressing element when the latch is at the closed position and to let the pressing element move when the latch is at the open position.

In some implementations, the frame includes a top portion having a curved portion configured to guide a movement of the pressing element, and a bottom portion including one or more first holes each configured to guide a movement of a slider of the one or more sliders, where the one or more flexible pins, the one or more sliders, and the pressing element are attached to the bottom portion of the frame, and the top portion of the frame is mounted onto the bottom portion of the frame.

A further aspect of the present disclosure features a method of assembling a computer hard drive to a slot of a computing system with a hard drive assembly. The method includes assembling a hard drive assembly onto a computer hard drive; arranging the hard drive assembly together with the computer hard drive onto a slot of a computing system; and disassembling the hard drive assembly from the computer hard drive, where the hard drive assembly includes: one or more flexible pins configured to be insertable into one or more mounting holes of the computer hard drive, a pressing element including one or more contact surfaces, and one or more sliders, and where each of the one or more sliders has a first sliding surface in contact with a respective contact surface of the pressing element and a second sliding surface in contact with a respective flexible pin of the one or more flexible pins.

In some implementations, assembling the hard drive assembly onto the computer hard drive includes placing the hard drive assembly onto the computer hard drive, such that each of one or more flexible holes of the hard drive assembly is aligned with a respective mounting hole of one or more mounting holes of the computer hard drive along a first direction; and pressing the hard drive assembly to cause the respective flexible pin to move through a corresponding flexible hole of the hard drive assembly into a corresponding mounting hole of the computer hard drive along the first direction and at least partially locked in the corresponding mounting hole of the computer hard drive.

In some implementations, pressing the hard drive assembly to cause the respective flexible pin to move into the corresponding mounting hole of the computer hard drive includes pressing down the pressing element along the first direction to cause each of the one or more sliders to move along a second direction different from the first direction through a contact between the first sliding surface and the respective contact surface of the pressing element to thereby cause the respective flexible pin to move up into a frame of the hard drive assembly through the corresponding flexible hole of the hard drive assembly; and releasing the pressing element to cause each of the one or more sliders to move along a direction opposite to the second direction to cause the respective flexible pin of the hard drive assembly to move down into the corresponding mounting hole of the computer hard drive along the first direction.

In some implementations, disassembling the hard drive assembly from the computer hard drive includes pressing the pressing element along a first direction to cause each of the one or more sliders to move along a second direction different from the first direction through a contact between the first sliding surface and the respective contact surface of the pressing element to thereby cause the respective flexible pin to move out from a corresponding mounting hole of the computer hard drive along the first direction.

In some implementations, the hard drive assembly includes a latch configured to prevent a movement of the pressing element when the latch is at an open position and to let the pressing element to move when the latch is at a closed position, and where the method includes: moving the latch at the closed position while assembling the hard drive assembly onto the computer hard drive, moving the latch at the closed position while disassembling the hard drive assembly from the computer hard drive, and moving the latch at the open position while arranging the hard drive assembly together with the computer hard drive onto the slot of the computing system to prevent the movement of the pressing element.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1A is a perspective view of an example computer hard drive.

FIGS. 1B-1C are perspective views of an example hard drive system.

FIG. 1D is a cross-sectional view of the hard drive assembly.

FIG. 2A is an exploded view of components of an example hard drive assembly.

FIG. 2B-2J are perspective views of the components of the example hard drive assembly of FIG. 2A.

FIG. 3A-3D show steps of assembling a hard drive assembly of FIG. 2A.

FIG. 4 is a flowchart of an example process of steps of assembling the hard drive assembly of FIG. 2A.

FIG. 5A-5D show steps of assembling a hard drive to a slot of a computing system.

FIG. 6 is a flowchart of an example process of steps of assembling a hard drive to a slot of a computing system.

FIG. 7A-7B show steps of assembling a hard drive assembly onto a computer hard drive.

FIG. 8A-8B show steps of disassembling a hard drive assembly onto a computer hard drive.

Like reference numbers and designations in the various drawings indicate like elements.

### DETAILED DESCRIPTION

During a service phase of a computing system (e.g., a server computer), because of the use of tools, the assembly and disassembly processes often have to be done in an assembly plant, which requires additional process time and leads to longer system downtime. On the other hand, the screws holding the hard drive handle and the computer hard drive also increase system complexity and material cost. Therefore, a device that can reduce server downtime and system complexity during the service phase with a simplified process is desirable.

In one or more implementations of the present disclosure, an example device to assemble and disassemble a computer hard drive of a computing system is provided. The device includes a pressing element including one or more contact surfaces; one or more flexible pins; and one or more sliders, where each of the one or more sliders has a first sliding surface configured to be in contact with a respective contact surface of the pressing element and a second sliding surface configured to be in contact with a respective flexible pin of the one or more flexible pins, where the pressing element is movable along a first direction to cause each of the one or more sliders to move along a second direction different from the first direction through a contact between the first sliding surface and the respective contact surface of the pressing element to thereby cause the respective flexible pin to move along the first direction by a movement of the second sliding surface.

Implementations of the present disclosure can provide one or more of the following technical advantages, effects, and/or benefits. First, the device according to the present disclosure does not require a screw connection between the device and the computer hard drive. In other words, operators can replace and change the computer hard drive at the service location, which reduces server downtime. Second, the device according to the present disclosure can be used without any tools. As a result, a tool-less service of replacing and changing the computer hard drive of the computing system can be achieved with the device presented in the disclosure. In other words, the device according to the present disclosure reduces system complexity.

Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

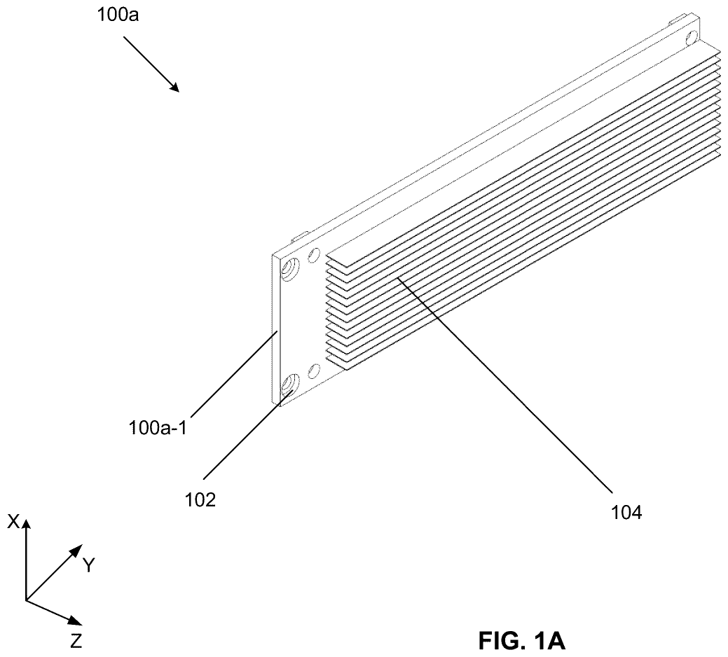

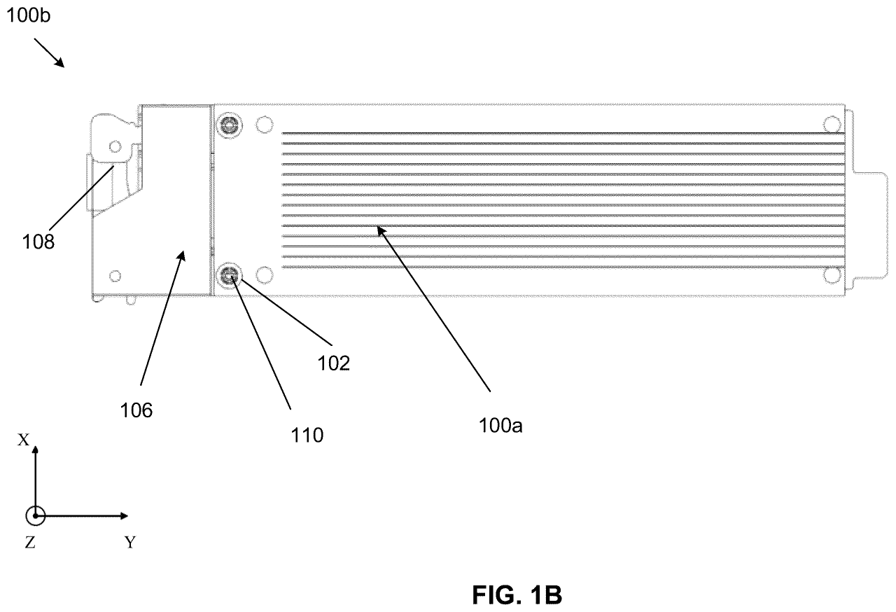

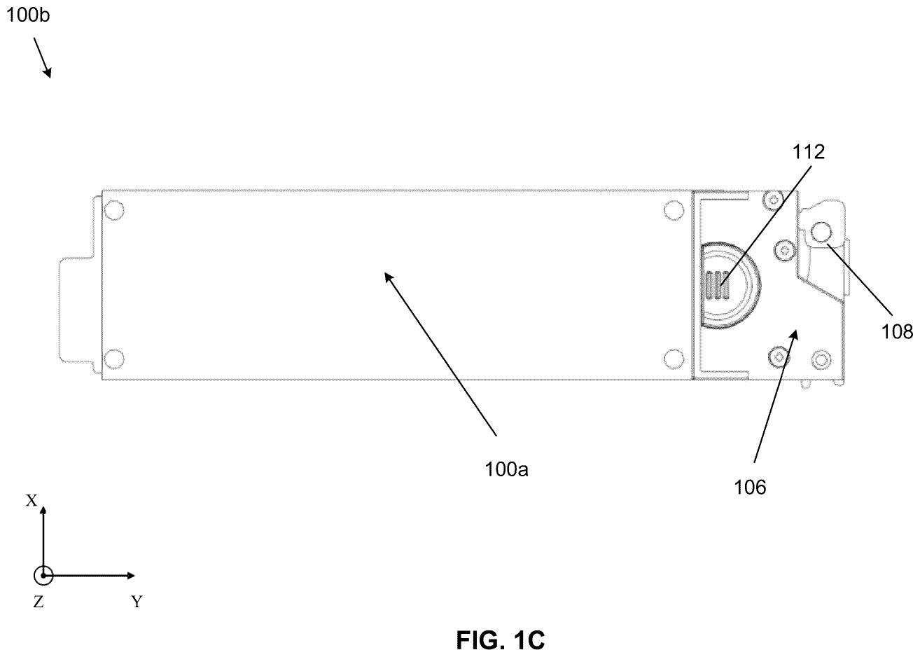

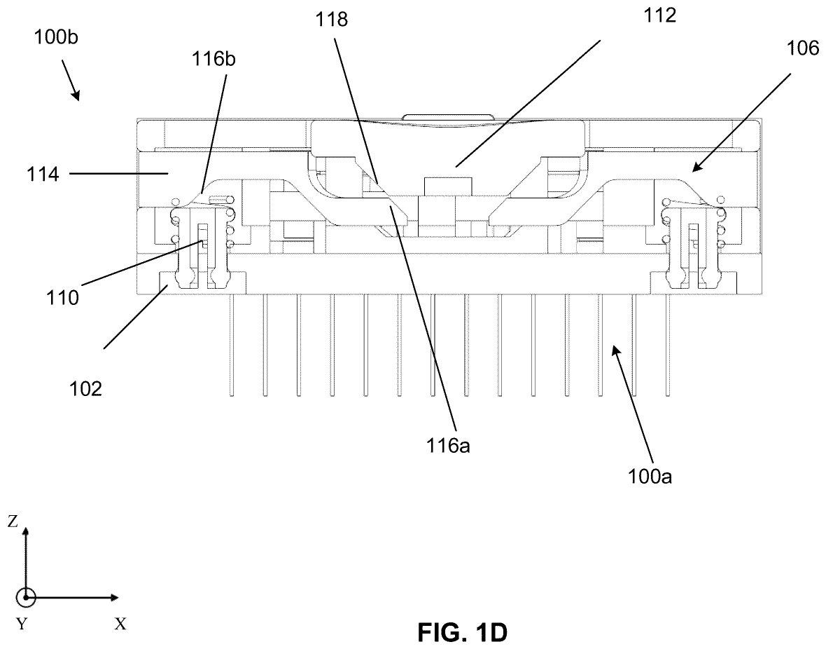

FIG. 1A illustrates a perspective view of an example computer hard drive 100a. As shown in FIG. 1, the computer hard drive 100a can be any hard drive that is used in a computing system. In some implementations, the computing system can be a computer server unit used in data center of data storage application. For example, the computer hard drive 100a can be an enterprise and data center standard format (EDSFF) solid-state drive (SSD) that is used in the computing system of a data center. In some implementations, the computer hard drive 100a includes two mounting holes 102 located on an end 100a-1 of the computer hard drive 100a. The two mounting holes 102 are on opposite sides of the computer hard drive along a first direction (e.g., the X direction). The two mounting holes 102 can be connected to a hard drive assembly (as shown in FIG. 1B) that is configured to secure the computer hard drive 100a onto the computing system. The computer hard drive 100a also includes a hard drive body 104. In some implementations, the hard drive body 104 and the two mounting holes 102 are arranged on opposite ends of the computer hard drive 100a along a second direction (e.g., the Y direction) perpendicular to the X direction. The hard drive body 104 can be a solid-state drive or any other suitable storage medium thereof. In some implementations, the hard drive body 104 can include an array of cooling structures. The cooling structures are configured to dissipate heat generated by the hard drive body 104 during normal operations.

FIG. 1B is a perspective view of a first side of a hard drive system 100b. The hard drive system includes a hard drive assembly 106 and the computer hard drive 100a arranged along the second direction (e.g., the Y direction). The hard drive assembly 106 can be a device that is configured to secure the computer hard drive 100a to a slot of the computing system. As shown in FIG. 1B, the hard drive assembly 106 includes a latch 108 and two flexible pins 110. The latch 108 can move between an open position (not shown in FIG. 1B) and a close position (as shown in FIG. 1B). The latch 108 is configured to secure the hard drive system 100b onto the slot of the computing system when it is at the close position.

In some implementations, the two flexible pins 110 are configured to extend through the two mounting holes 102 of the computer hard drive 100a and secure the computer hard drive 100a to the hard drive assembly 106 along a third direction (e.g., the Z direction) perpendicular to the X direction and the Y direction.

FIG. 1C is a perspective view of a second side of the hard drive system 100b. In some implementations, the second side of the hard drive system 100b of FIG. 1C is on opposite side of the first side of the hard drive system 100b of FIG. 1B along the third direction (e.g., the Z direction). As shown in FIG. 1C, the hard drive assembly 106 includes a pressing element 112 that is configured to move along the third direction and cause the two flexible pins 110 to move along the third direction.

FIG. 1D illustrates a cross-sectional view of the hard drive system 100b. As shown in FIG. 1D, the hard drive assembly 106 further includes one or more sliders 114 having a first sliding surface 116a and a second sliding surface 116b. The pressing element 112 includes one or more contact surfaces 118. In some implementations, the first slide surface of each of the one or more sliders 114 is configured to be in contact with a respective contact surface 118 of the pressing element 112, and the second sliding surface 116b is configured to be in contact with a respective flexible pin 110. In some implementations, the pressing element is movable along the third horizontal direction (e.g., the Z direction) and cause the one or more sliders 114 to move along the first direction (e.g., the X direction) through the contact between the first sliding surface 116a and the respective contact surface 118 to thereby cause the respective flexible pin 110 to move along the third direction (e.g., the Z direction) by a movement of the second sliding surface 116b. In one example, a movement of the flexible pins 110 can be used to attach the computer hard drive 100a to the hard drive assembly 106. In another example, the movement of the flexible pins 110 can be used to detach the computer hard drive 100a from the hard drive assembly 106.

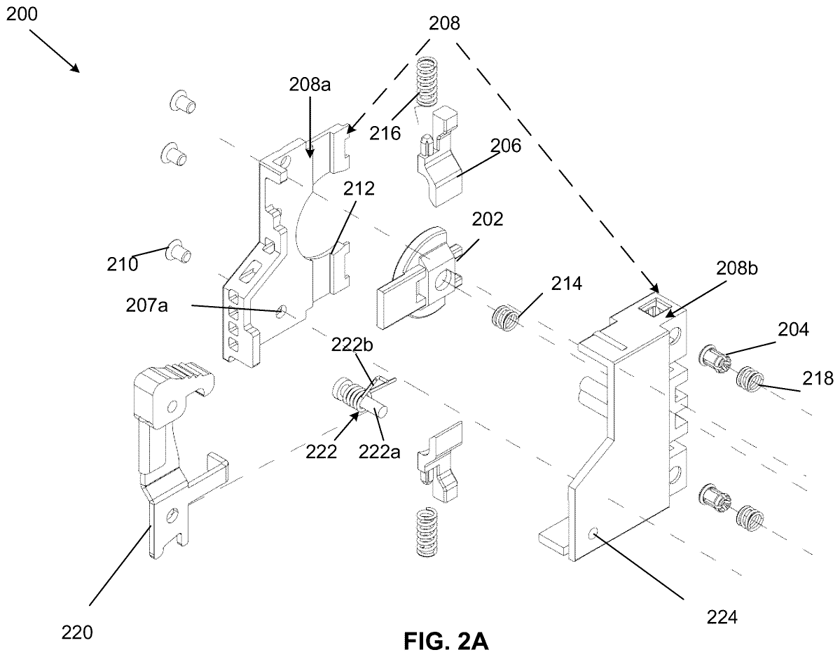

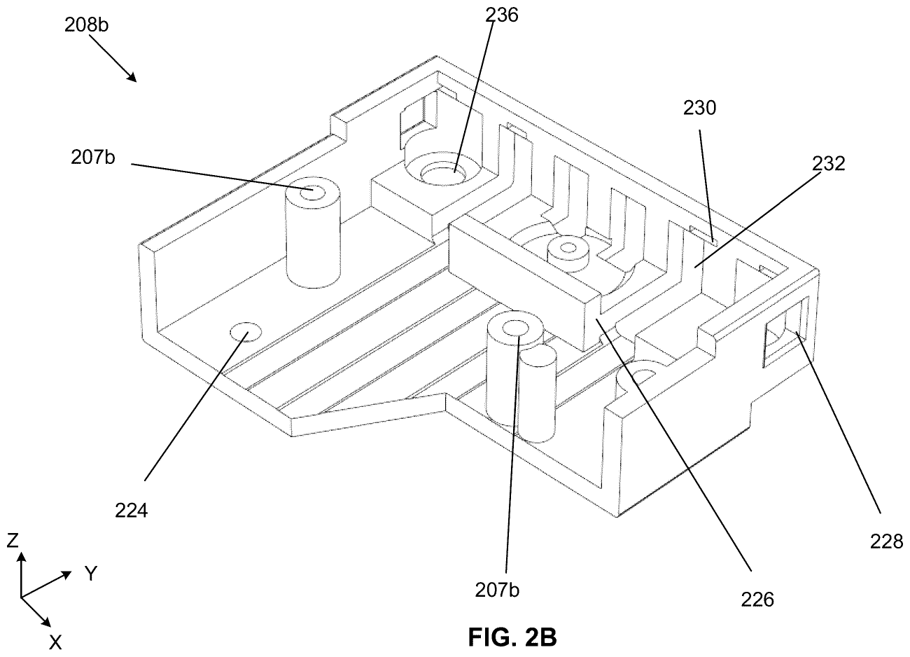

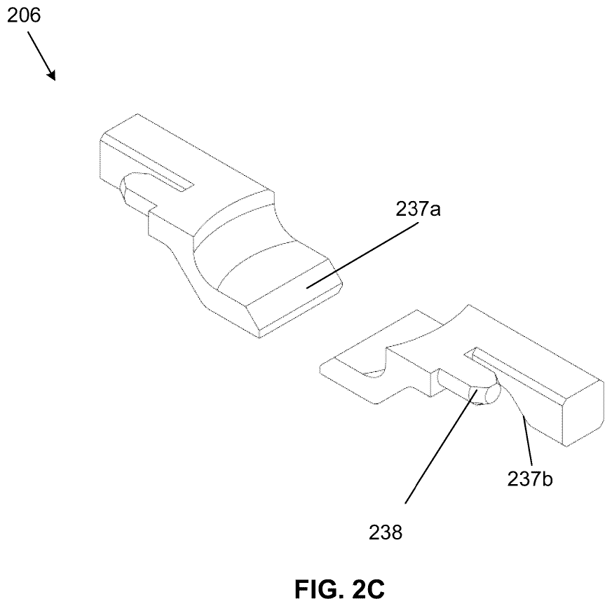

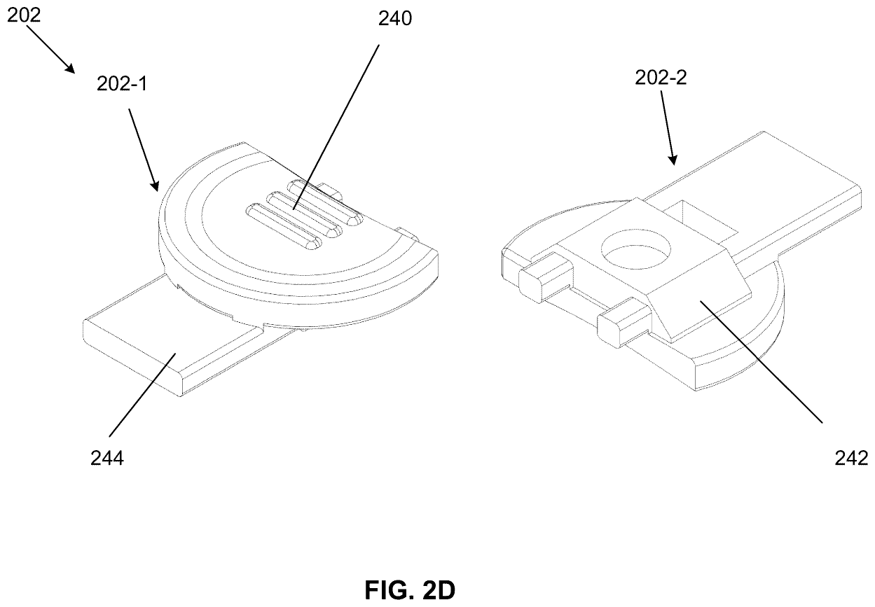

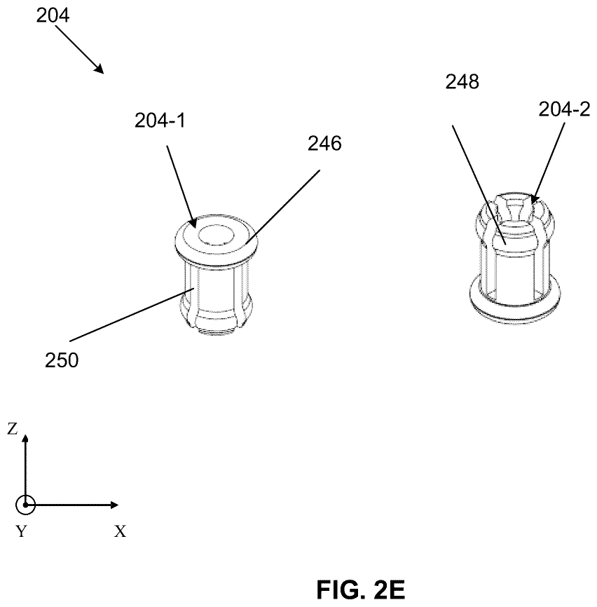

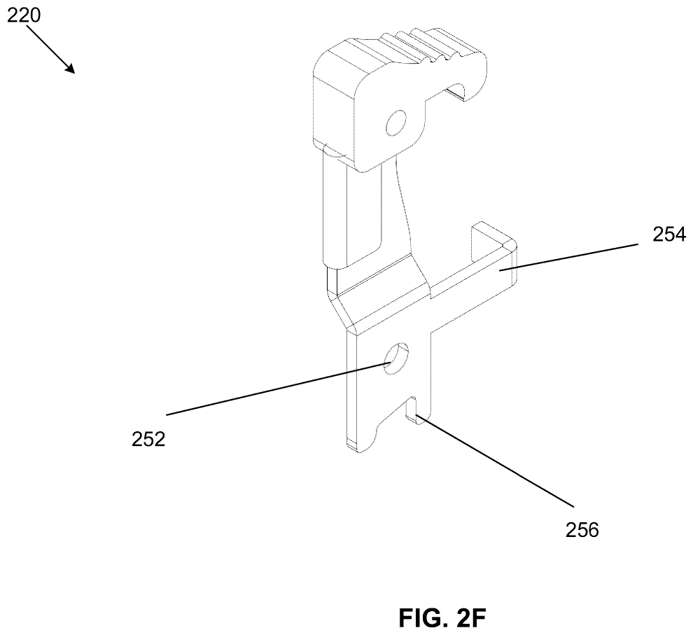

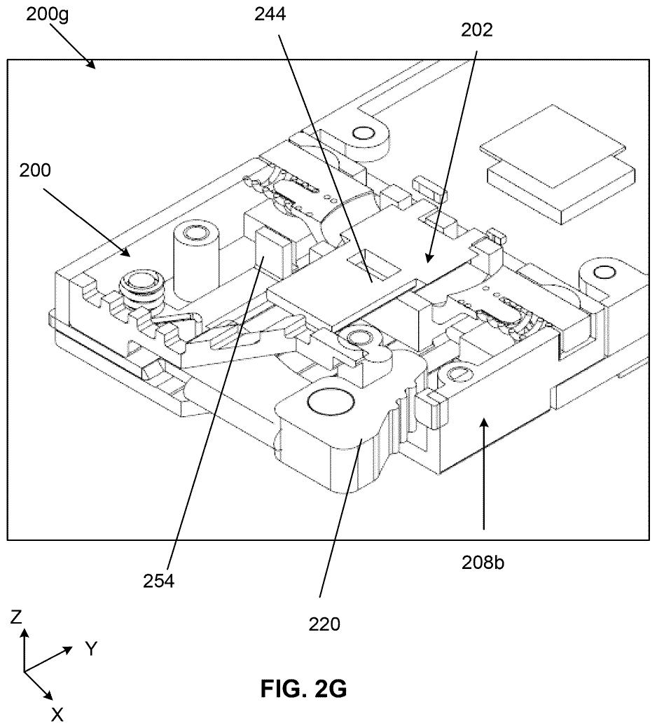

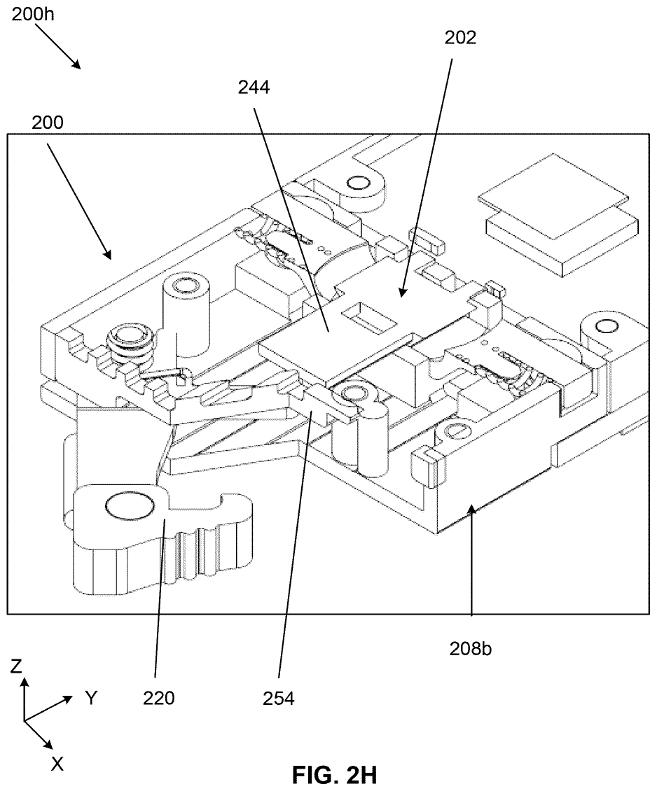

FIG. 2A is an exploded view of components of an example hard drive assembly 200. In some implementations, the hard drive assembly 200 can be similar to, or same as the hard drive assembly 106 of FIG. 1B.

As shown in FIG. 2A, the hard drive assembly 200 includes a pressing element 202, one or more flexible pins 204, and one or more sliders 206. In some implementations, the pressing element 202 can be similar to, or same as the pressing element 112 of the hard drive system 100b of FIG. 1C. The one or more flexible pins 204 can be similar to, or same as the flexible pins 110 of the hard drive system 100b of FIG. 1B. The one or more sliders 206 can be similar to, or same as the one or more sliders 114 of the hard drive system 100b of FIG. 1B.

In some implementations, the hard drive assembly 200 further includes a frame 208 that is configured to hold the pressing element 202, the one or more flexible pins 204, and the one or more sliders 206. As shown in FIG. 2A, the frame 208 includes a top portion 208a and a bottom portion 208b. In some implementations, the top portion 208a and the bottom portion 208b of the frame 208 are mounted together by at least one locking screw 210. For example, as shown in FIG. 2A, the at least one locking screw 210 extends through a top locking hole 207a of the top portion 208a and a bottom locking hole 207b (as shown in FIG. 2B) of the bottom portion 208b to secure the top portion 208a and the bottom portion 208b of the frame 208 together. In some implementations, the top portion 208a of the frame 208 includes a curved portion 212 that is configured to guide a movement of the pressing element 202.

The pressing element 202 is attached to the bottom portion 208b of the frame 208 through a pressing spring 214. In some implementations, the pressing spring 214 is configured to reposition the pressing element 202 with respected to the bottom portion 208b of the frame 208. Each of the one or more sliders 206 is attached to the bottom portion 208b of the frame 208 through a respective sliding spring 216. In some implementations, the respective sliding spring 216 is configured to repositing the slider 206 with respected to the bottom portion 208b of the frame 208. Each of the one or more flexible pins 204 is attached to the bottom portion 208b of the frame 208 through a flexible spring 218. In some implementations, the flexible spring 218 is configured to reposition the flexible pin 204 with respected to the bottom portion 208b of the frame 208.

In some implementations, the hard drive assembly 200 also includes a latch 220. In some implementations, the latch 220 can be similar to, or same as the latch 108 of the hard drive system 100b of FIG. 1B. In some implementations, the latch 220 is attached to the frame 208 by a rotating pin 222. In some implementations, the latch 220 is moveable between an open position and a closed position through a rotation of the rotating pin 222. In some implementations, the rotating pin 222 includes a body 222a and a spring 222b. The body 222a of the rotating pin is configured to secure the latch 220 to the frame 208, and the spring 222b is configured to repositing the latch 220 with respected to the frame 208. In some implementations, the body 222a of the rotating pin 222 secures the latch 220 to the frame 208 thought a rotating hole 224 of the bottom portion 208b of the frame 208.

FIG. 2B is a perspective view of the bottom portion 208b of the frame 208 of the hard drive assembly 200 of FIG. 2A. As shown in FIG. 2B, the bottom portion 208b of the frame 208 includes one or more bottom locking holes 207b. In some implementations, a number of the one or more bottom locking holes 207b various between one to three and is configured to match a number of the one or more locking screws 210 that are used to secure the top portion 208a and the bottom portion 208b of the frame 208 together. For example, as shown in FIG. 2B, the number of the one or more bottom locking holes 207b of the bottom portion 208b of the frame 208 is two.

In some implementations, the bottom portion 208b includes one or more locking modules 230. The one or more locking modules 230 are configured to positing the top portion 208a of the frame 208 and secure the top portion 208a and the bottom portion 208b of the frame 208 together.

As shown in FIG. 2B, the bottom portion 208b of the frame 208 also includes one or more flexible holes 236. In some implementations, the flexible pin 204 is configured to move through a corresponding flexible hole 236 of the bottom portion 208b of the frame 208. In some implementations, a diameter of the corresponding flexible hole 236 is smaller than a diameter of the flexible spring 218. The flexible spring 218 is configured to repositing the flexible spring 218 by causing a movement of the flexible spring 218 through the corresponding flexible hole 236.

In some implementations, the bottom portion 208b of the frame 208 includes a blocking element 226 and one or more first holes 228. The blocking element 226 is configured to limit a range of a movement of the pressing element 202 along a third direction (e.g., the Z direction), and each of the one or more first holes 228 is configured to limit a range of a movement of a corresponding slider 206 along a first direction (e.g., the X direction) different from the third direction. For example, as shown in FIG. 2A-2B, the hard drive assembly 200 includes one pressing element 202 and two sliders 206. The bottom portion 208a of the frame includes a blocking element 226 and two first holes 228. The blocking element 226 is configured to limit the movement of the pressing element 202 along the third direction (e.g., the Z direction) and the two first holes 228 is configured to limit the movement of the two sliders 206 along the first direction (e.g., the X direction) perpendicular to the Z direction.

In some implementations, the bottom portion 208b of the frame 208 also includes vents 232 that is configured to release heat generated by a hard drive (e.g., the computer hard drive 100a of FIG. 1A) during an operation of the hard drive.

In some implementations, the top portion 208a and the bottom portion 208b of the frame 208 defines a space that can be used to integrate different parts of the hard drive assembly 200 together. For example, the pressing element 202, the one or more flexible pins 204, the one or more sliders 206, and the latch 220 are all attached to the frame 208 to form the hard drive assembly 200.

FIG. 2C is a perspective view of the one or more sliders 206 of the hard drive assembly 200 of FIG. 2A. As shown in FIG. 2C, each of the one or more sliders includes a first sliding surface 237a and a second sliding surface 237b. In some implementations, the first sliding surface 237a is in contact with the pressing element 202 of the hard drive assembly 200 of FIG. 2A and the second sliding surface 237b is in contact with a corresponding flexible pin 204 of the hard drive assembly 200 of FIG. 2A.

In some implementations, as shown in FIG. 2C, each of the one or more sliders 206 includes a sliding pin 238 adjacent to the second sliding surface 237b. In some implementations, the sliding pin 238 is surrounded by the sliding spring 216 of the hard drive assembly 200 of FIG. 2A. In some implementations, the sliding pin 238 is configured to limit a range of a movement of the slider 206 by contacting the bottom portion 208b of the frame 208.

FIG. 2D illustrates perspective views of the of the pressing element 202 hard drive assembly 200 of FIG. 2A. As shown in FIG. 2D, the pressing element 202 includes a first side 202-1 and a second side 202-2. The first side 202-1 of the pressing element includes grooves 240. The grooves 240 is configured to assist the movement of the pressing element. For example, a user (e.g., a human or a robot arm) can press down on the pressing element to assemble or disassembly a hard drive (e.g., the computer hard drive 100a of FIG. 1A) from the hard drive assembly 200 of FIG. 2A. the grooves 240 can increase the fraction between the user and the pressing element 202.

The pressing element 202 also includes contact surfaces 242 on the second side 202-2 of the pressing element 202. In some implementations, each of the contact surfaces 242 are configured to be in contact with a corresponding first sliding surface 237a of the one or more sliders 206 of FIG. 2C. In some implementations, the pressing element 202 is movable along the third direction to cause the one or more sliders 206 to move along the first direction different from the third direction through the contact between the contact surfaces 242 and corresponding first sliding surfaces 237a of the one or more slider 206.

In some implementations, the pressing element 202 also includes a positioning module 244. In some implementations, during the movement of the pressing element 202, the positioning module 244 is configured to be in contact with the blocking element 226 of the bottom portion 208b of the frame 208 to limit a range of the movement of the pressing element 202.

FIG. 2E is a perspective view of the flexible pin 204 of the hard drive assembly 200 of FIG. 2A. As shown in FIG. 2E, the flexible pin 204 has a first end 204-1 and a second end 204-2 that are opposite to each other along the third direction (e.g., the Z direction). The flexible pin 204 includes a contact structure 246 on the first end 204-1 of the flexible pin 204 and a connection module 248 on the second end of the flexible pin 204. In some implementations, the contact structure 246 and the connection module 248 are connected together by a flexible structure 250. In some implementations, the contact structure 246, the flexible structure 250, and the connection module 248 are integrated into a single piece to form the flexible pin 204.

In some implementations, the contact structure 246 is configured to be in contact with a corresponding second sliding surface (e.g., the second sliding surface 237b of FIG. 2C of a corresponding slider (e.g., the slider 206 of FIG. 2C). In some implementations, a diameter of the contact structure 246 is greater than a diameter of a corresponding flexible hole (e.g., the flexible hole 236 of FIG. 2B) to prevent the flexible pin 204 from extending through the corresponding flexible hole 236.

In some implementations, the connection module 248 is configured to move through a corresponding mounting hole (e.g., each of the two mounting holes 102 of FIG. 1A) of a computer hard drive (e.g., the computer hard drive 100a of FIG. 1A) and secure the computer hard drive. In some implementations, the flexible structure 250 is configured to shrink when the flexible pin 204 is moving along the third direction which allows the connection module 248 to move through the corresponding mounting hole. In some implementations, a cross-sectional area of the connection module 248 is greater than a cross-sectional area of the corresponding mounting hole when the flexible structure 250 is at a stational position so that the computer hard drive can be locked onto the hard drive assembly 200.

FIG. 2F is a perspective view of the latch 220 of the hard drive assembly 200 of FIG. 2A. As shown in FIG. 2F, the latch 220 is attached to a frame (e.g., the frame 208 of FIG. 2A) by a rotating pin (e.g., the rotating pin 222 of FIG. 2A). In some implementations, the rotating pin extends through an inner rotating hole 252 of the latch 220 to secure the latch 220 onto the frame. In some implementations, the latch 220 is moveable between an open position and a closed position through a rotation of the rotating pin.

The latch 220 further includes a blocking module 254. In one example, the blocking module 254 is configured to prevent a movement of a pressing element (e.g., the pressing element 202 of FIG. 2A) when the latch 220 is at the open position. In another example, the blocking module 254 allows the pressing element to move when the latch is at the closed position.

In some implementations, the latch 220 also includes a position limiting module 256. The position limiting module 256 is configured to secure the hard drive assembly and the hard drive on to a slot of the computing system.

FIG. 2G-2H are exploded views of the hard drive assembly 200 when the latch 220 is at a close position 200g and an open position 200h.

As shown in FIG. 2G, when the latch 220 is at the close position 200g, the blocking module 254 is not aligned with the positioning module 244 of the pressing element 202. As shown in FIG. 2G, the blocking module 254 is adjacent to the positioning module 244 along the first direction (e.g., the X direction), where the positioning module 244 can move freely in the third direction (e.g., the Z direction) in a space defined by the bottom portion 208b of the frame 208 and the position of the blocking module 254 when the latch 220 is at the close position 200g. In other words, the pressing element 202 can freely move in the third direction (e.g., the Z direction).

As shown in FIG. 2H, when the latch 220 is at the open position 200h, the blocking module 254 is aligned with the positioning module 244 of the pressing element 202. As shown in FIG. 2H, the blocking module 254 is between the bottom portion 208b of the frame 208 and the positioning module 244 along the third direction (e.g., the Z direction). A movement of the pressing element 202 along the third direction (e.g., the Z direction) is limited by the blocking module 254 and the positioning module 244.

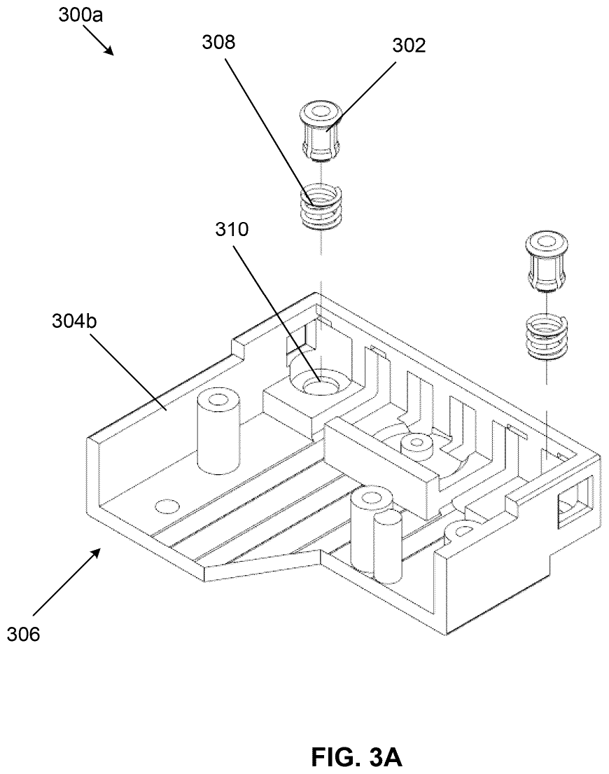

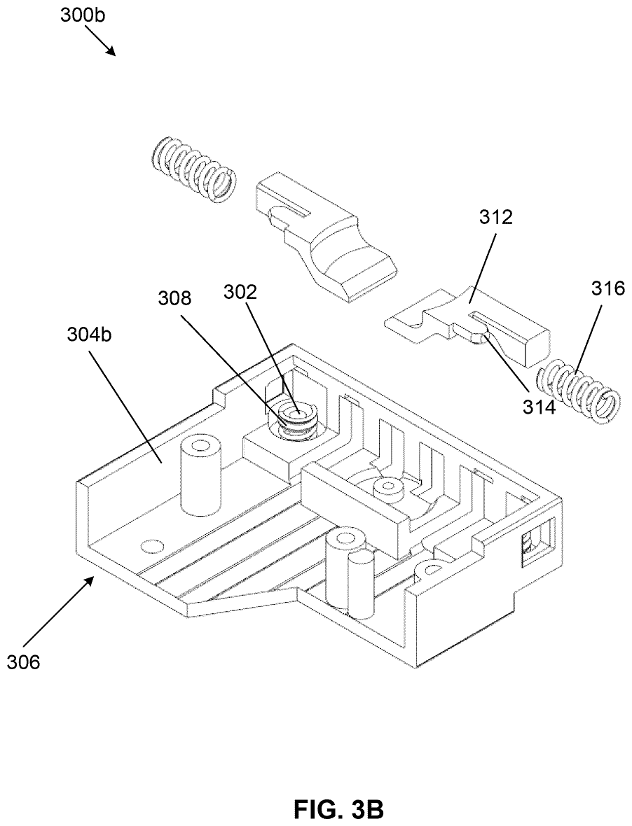

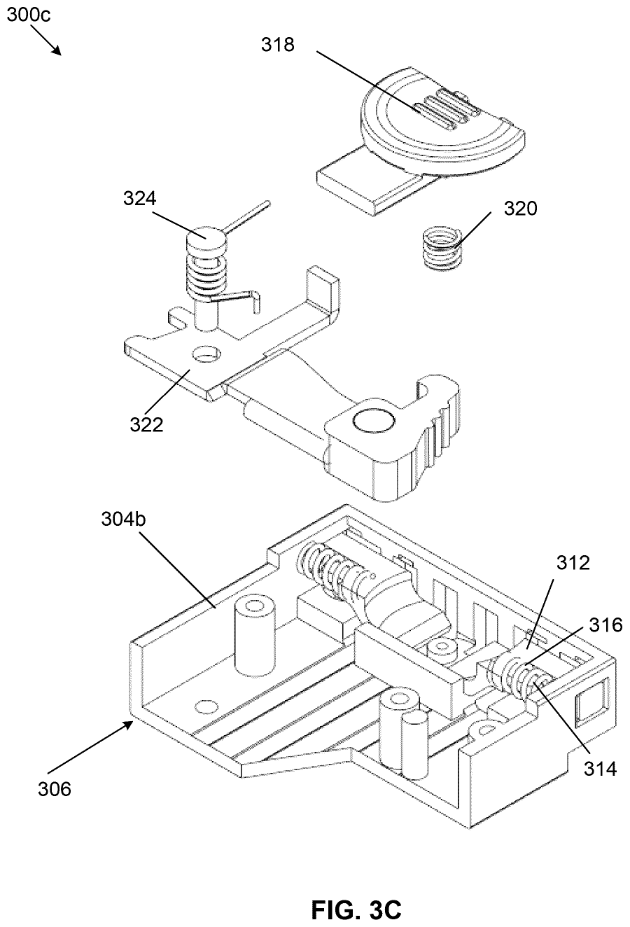

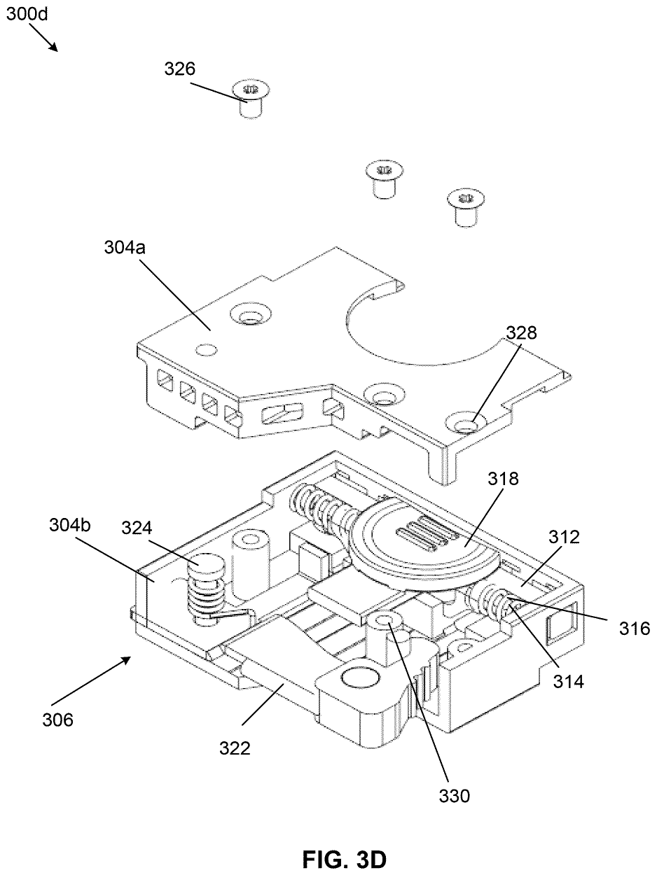

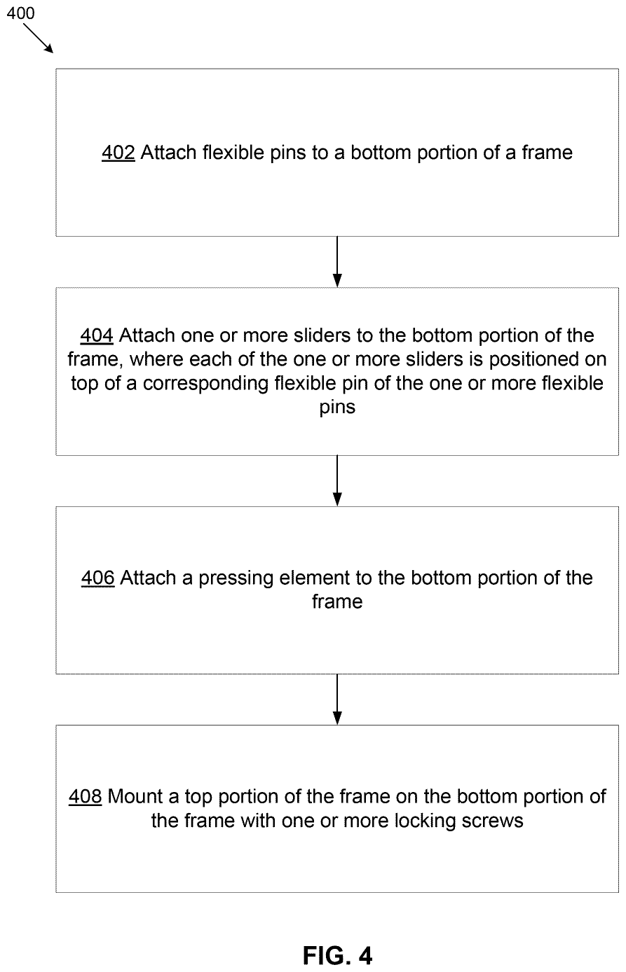

FIG. 3A-3D show steps of assembling a hard drive assembly, according to an implementation of the present disclosure. The steps of FIG. 3A-3D can be used to assemble components of the hard drive assembly 200 of FIG. 2A. FIG. 4 illustrate a flow chart 400 of steps of assembling the hard drive assembly, according to an implementation of the present disclosure.

At operation 402, flexible pins are attached to a bottom portion of a frame. For example, as shown in step 300a, two flexible pins 302 are attached to a bottom portion 304b of a frame 306. In some implementations, each of the two flexible pins 302 is surrounded by a corresponding flexible spring 308. In some implementations, as shown in FIG. 3A, the bottom portion 304b of the frame 306 includes one or more flexible holes 310, where the two flexible pins 302 are aligned with a respective flexible hole 310. In some implementations, each of the two flexible pins 302 are similar to, or same as, the flexible pin 204 of FIG. 2E. In some implementations, the corresponding flexible spring 308 is similar to, or same as, the flexible spring 218 of FIG. 2A. In some implementations, the bottom portion 304b of the frame 306 is similar to, or same as, the bottom portion 208b of the frame 208 of FIG. 2A. In some implementations, the one or more flexible holes 310 are similar to, or same as, the one or more flexible holes 236 of FIG. 2B.

At operation 404, one or more sliders are attached to the bottom portion of the frame, where each of the one or more sliders is positioned on top of a corresponding flexible pin of the one or more flexible pins. For example, as shown in step 300b, one or more sliders 312 are attached to the bottom portion 304b of the frame 306. In some implementations, each of the one or more sliders 312 is positioned on top of a corresponding flexible pin 302. In some implementations, each of the one or more sliders 312 includes a sliding pin 314, where the slider 312 is attached to the bottom portion 304b of the frame 306 by a respective sliding spring 316 that surrounds the sliding pin 314. In some implementations, the one or more sliders 312 are similar to, or same as, the one or more sliders 206 of FIG. 2A. In some implementations, the sliding pin 314 is similar to, or same as, the sliding pin 238 of FIG. 2C. In some implementations, the sliding spring 316 is similar to, or same as, the sliding spring 216 of FIG. 2A.

At operation 406, a pressing element is attached to the bottom portion of the frame. For example, as shown in step 300c. A pressing element 318 is attached to the bottom portion 304b of the frame 306 by a pressing spring 320. In some implementations, the hard drive assembly 200 also includes a latch 322. The latch 322 is attached to the bottom portion of 304b of the frame 306 by a rotating pin 324. In some implementations, the pressing element 318 can be similar to, or same as the pressing element 202 of FIG. 2A. In some implementations, the pressing spring 320 can be similar to, or same as the pressing spring 214 of FIG. 2A. In some implementations, the latch 322 can be similar to, or same as the latch 220 of FIG. 2A. In some implementations, the rotating pin 324 can be similar to, or same as the rotating pin 222 of FIG. 2A.

At operation 408, a top portion of the frame is mounted on the bottom portion of the frame with one or more locking screws. For example, as shown in step 300d, a top portion 304a of the frame 306 is mounted on top of the bottom portion 304b of the frame 306 by one or more locking screws 326. In some implementations, the top portion 304a includes one or more top locking holes 328 and the bottom portion 304b includes one or more bottom locking holes 330. The one or more locking screws 326 secure the top portion 304a and the bottom portion 304b of the frame 306 together. In some implementations, the top portion 304a can be similar to, or same as the top portion 208a of FIG. 2A. In some implementations, the one or more locking screws can be similar to, or same as the one or more locking screws 210 of FIG. 2A. In some implementations, the one or more top locking holes 328 can be similar to, or same as the one or more top locking holes 207a of FIG. 2A. In some implementations, the one or more bottom locking holes 330 can be similar to, or same as the one or more bottom locking holes 207b of FIG. 2B.

In some implementations, the one or more flexible pins are attached to the frame by one or more flexible springs, the one or more sliders are attached to the frame by one or more sliding springs, and the pressing element is attached to the frame by a pressing spring.

In some implementations, the method further includes attaching a latch to the frame by a rotating pin, where the latch is moveable between an open position and a closed position through a rotation of the rotating pin, and the latch includes a blocking module configured to prevent a movement of the pressing element when the latch is at the closed position and to let the pressing element move when the latch is at the open position.

In some implementations, the frame includes a top portion having a curved portion configured to guide a movement of the pressing element, and a bottom portion including one or more first holes each configured to guide a movement of a slider of the one or more sliders, where the one or more flexible pins, the one or more sliders, and the pressing element are attached to the bottom portion of the frame, and the top portion of the frame is mounted onto the bottom portion of the frame.

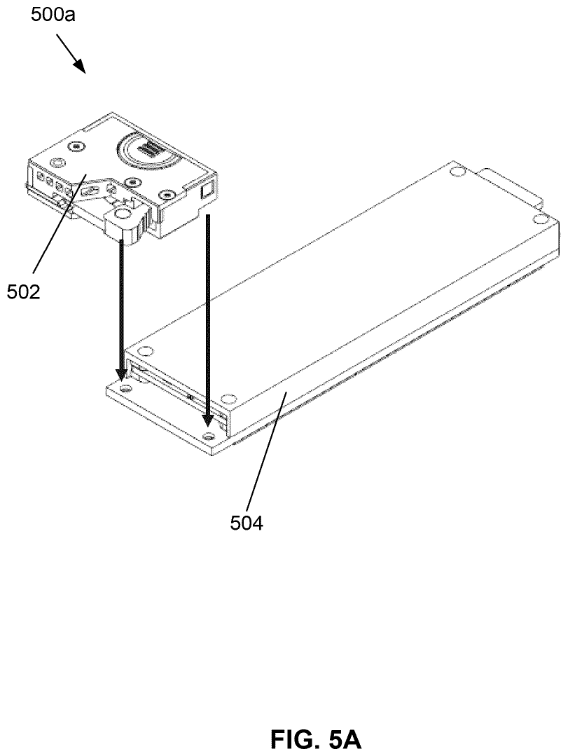

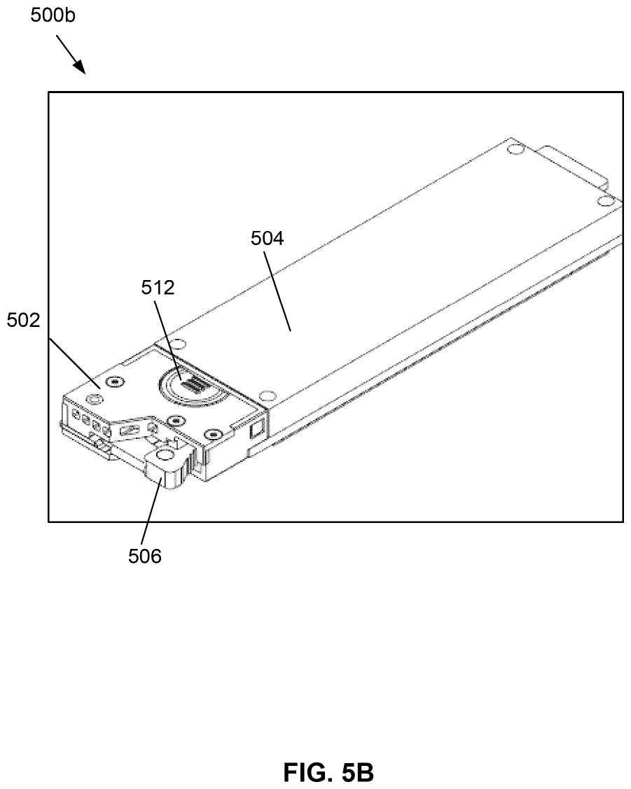

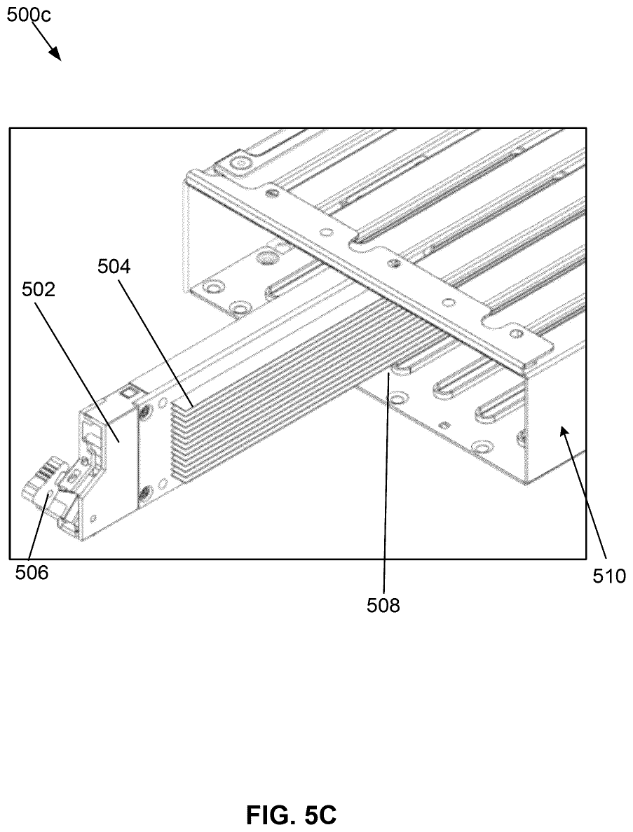

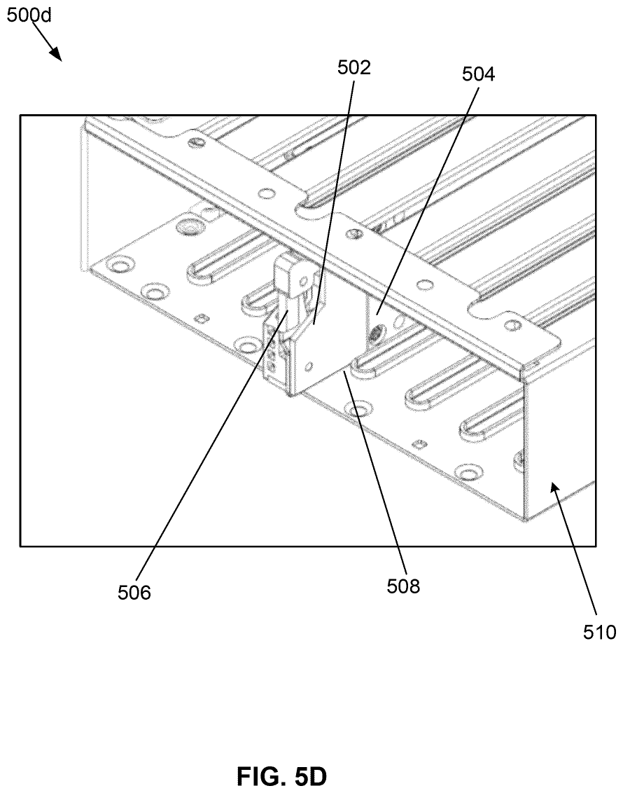

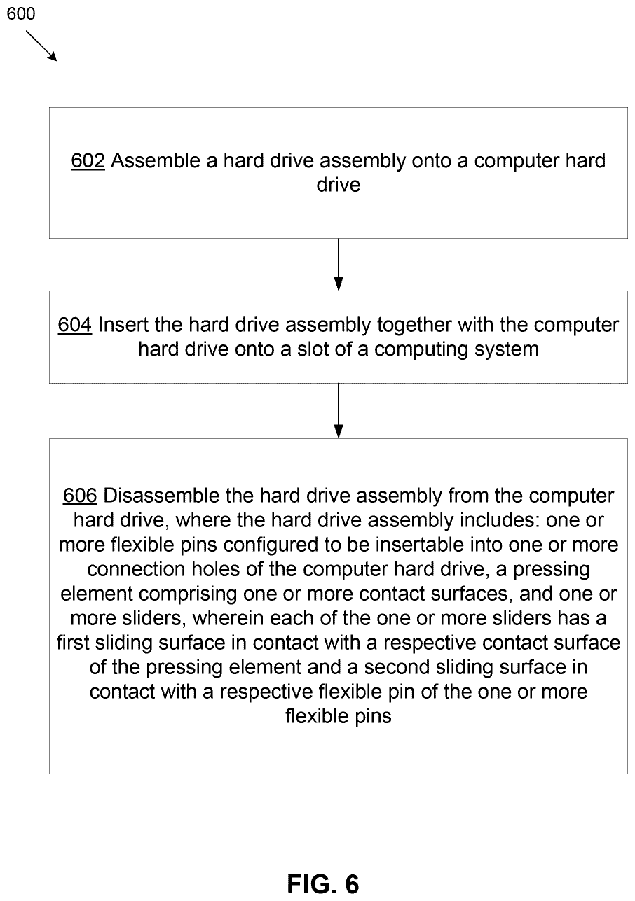

FIG. 5A-5D show steps of assembling a computer hard drive to a slot of a computing system, according to an implementation of the present disclosure. The steps of FIG. 5A-5D can be used to assembly the computer hard drive 100a of FIG. 1A to the slot of the computing system. FIG. 6 illustrate a flow chart 600 of steps of assembling and disassembling the computer hard drive to the slot of the computing system, according to an implementation of the present disclosure.

At operation 602, a hard drive assembly is assembled onto a computer hard drive. For example, as shown in step 500a, a hard drive assembly 502 is assembled onto a computer hard drive 504. In some implementations, the hard drive assembly 502 can be similar to, or same as the hard drive assembly 200 of FIG. 2A. In some implementations, the computer hard drive 504 can be similar to, or same as the computer hard drive 100a of FIG. 1A.

In some implementations, as shown in FIG. 5A, assembling the hard drive assembly 502 onto the computer hard drive 504 includes placing the hard drive assembly 502 onto the computer hard drive 504, such that each of one or more flexible holes (e.g., the one or more flexible holes 236 of FIG. 2B) of the hard drive assembly 502 is aligned with a respective mounting hole (e.g., the mounting hole 102 of FIG. 1A) of one or more mounting holes of the computer hard drive 504 along a first direction; and pressing the hard drive assembly to cause the respective flexible pin to move through a corresponding flexible hole of the hard drive assembly into a corresponding mounting hole of the computer hard drive along the first direction and at least partially locked in the corresponding mounting hole of the computer hard drive.

FIG. 5B illustrates a step 500b. As shown in the step 500b, the hard drive assembly 502 is assembled onto the computer hard drive 504. In some implementations, the hard drive assembly 502 includes a latch 506. The latch 506 is movable between an open position and a close position. As shown in the step 500b, the latch 506 is at the close position during the assembly of the hard drive assembly 502 onto the computer hard drive 504.

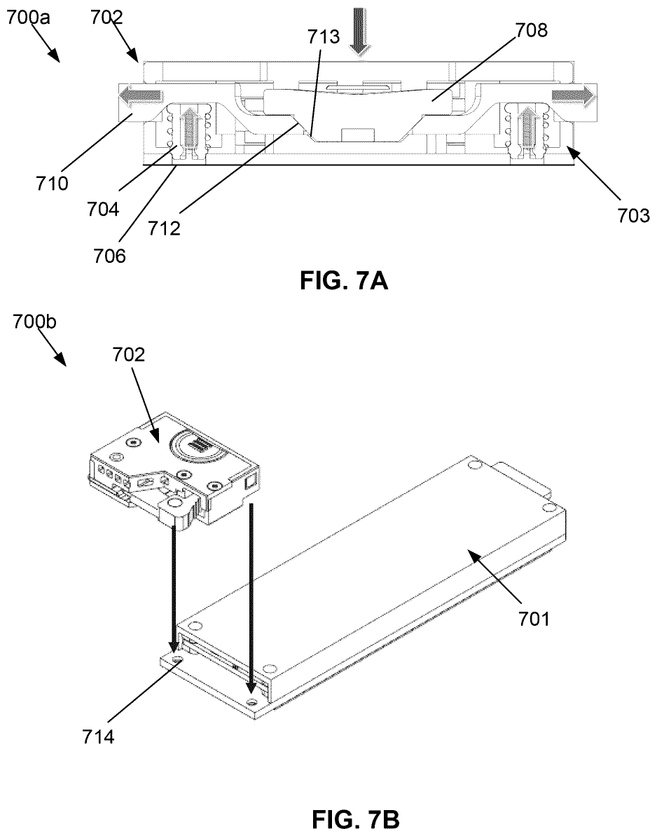

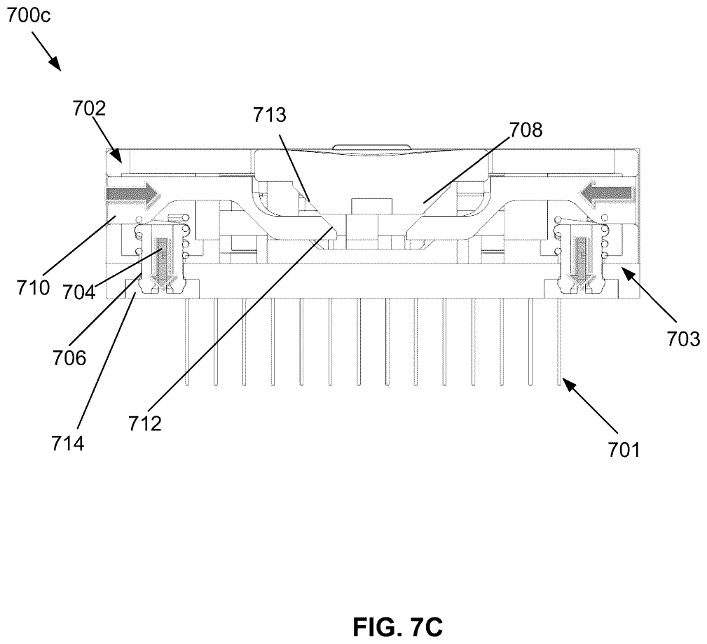

FIG. 7A-7C illustrate steps of assembling a hard drive assembly to the computer hard drive, according to an implementation of the present disclosure. In some implementations, the hard drive assembly 502 can be assembled onto the computer hard drive 504 in the steps illustrated in FIG. 7A-7C.

FIG. 7A illustrates step 700a. As shown in the step 700a, each of flexible pins 704 of a hard drive assembly 702 is retracted into a corresponding flexible hole 706 by pressing down a pressing element 708 along a first direction. In some implementations, pressing down the pressing element 708 along the first direction causes each of one or more sliders 710 to move along a second direction different from the first direction through a contact between a first sliding surface 712 and a respective contact surface 713 of the pressing element 708 to thereby cause a respective flexible pin 704 to move up into a frame 703 of the hard drive assembly 702 through the corresponding flexible hole 706 of the hard drive assembly 702. In some implementations, the hard drive assembly 702 is similar to, or same as the hard drive assembly 200 of FIG. 2A.

FIG. 7B illustrate step 700b. As shown in the step 700b, the hard drive assembly 702 is aligned with a computer hard drive 701 such that flexible holes 706 of the hard drive assembly 702 are aligned with corresponding mounting holes 714 of the computer hard drive 701. In some implementations, the computer hard drive 701 is similar to, or same as the computer hard drive 100a of FIG. 1A.

FIG. 7C illustrate step 700c. As shown in the step 700c, the hard drive assembly 702 is attached to the computer hard drive 701. In some implementations, attaching the hard drive assembly 702 to the computer hard drive 701 includes releasing the pressing element 708 to cause each of the one or more sliders 710 to move along a direction opposite to the second direction to cause the respective flexible pin 704 of the hard drive assembly 702 to move down into the corresponding mounting hole 714 of the computer hard drive 701 along the first direction.

At operation 604, the hard drive assembly together with the computer hard drive are arranged onto a slot 508 of a computing system 510. For example, as shown in step 500c, the latch 506 is moved to the open position while arranging the hard drive assembly 502 together with the computer hard drive 504 drive onto the slot 508 of the computing system 510 to prevent the movement of a pressing element (e.g., the pressing element 512 as shown in FIG. 5B) of the hard drive assembly 502. In some implementations, the hard drive assembly 502 together with the computer hard drive 504 are inserted into the slot 508.

FIG. 5D illustrates step 500d. As shown in the step 500d, the latch 506 is moved back to the closed position to secure the hard drive assembly 502 together with the computer hard drive 504 drive onto the slot 508 of the computing system 510.

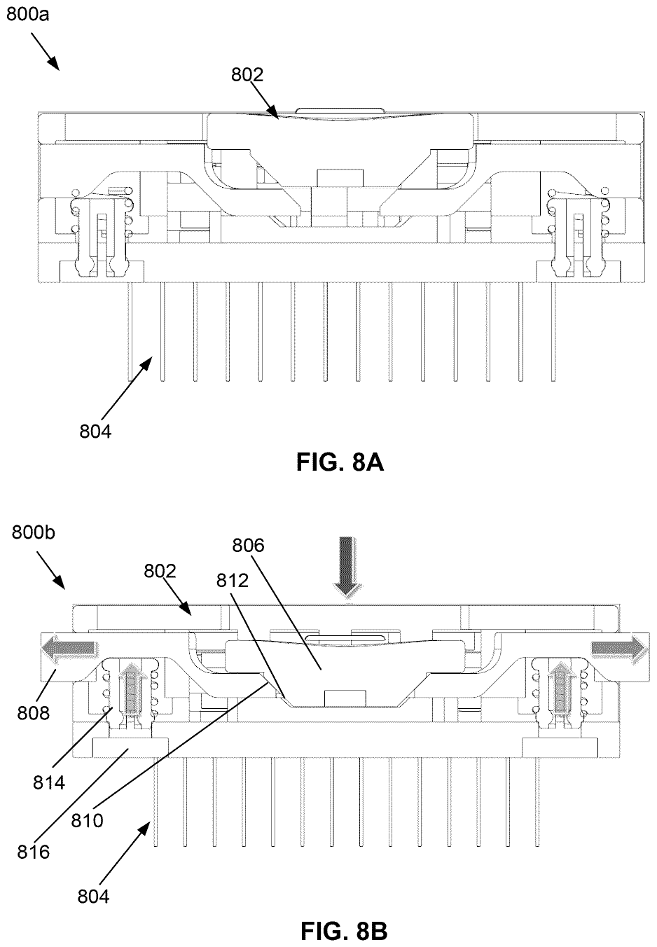

At operation 606, the hard drive is disassembled from the computer hard drive. For example, FIG. 8A-8B illustrate steps of disassembling a hard drive assembly from the computer hard drive, according to an implementation of the present disclosure.

FIG. 8A illustrate step 800a. At step 800a, a hard drive assembly 802 together with a computer hard drive 804 are removed from a slot (e.g., the slot 508 of FIG. 5C) of a computing system (e.g., the computing system 510 of FIG. 5C). In some implementations, the hard drive assembly 802 can be similar to, or same as the hard drive assembly 200 of FIG. 2A. In some implementations, the computer hard drive 804 can be similar to, or same as the computer hard drive 100a of FIG. 1A.

FIG. 8B illustrate step 800b. At step 800b, the hard drive assembly 802 is disassembled from the computer hard drive 804. In some implementations, disassembling the hard drive assembly from the computer hard drive includes pressing a pressing element 806 along a first direction to cause each of one or more sliders 808 to move along a second direction different from the first direction through a contact between a first sliding surface 810 and a respective contact surface 812 of the pressing element 806 to thereby cause a respective flexible pin 814 to move out from a corresponding mounting hole 816 of the computer hard drive 804 along the first direction.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results.

Accordingly, the previously described example implementations do not define or constrain the present disclosure. Other changes, substitutions, and alterations are also possible without departing from the scope of the present disclosure.

What is claimed is:

1. A device, comprising:
a pressing element comprising one or more contact surfaces;
one or more flexible pins; and
one or more sliders, wherein each of the one or more sliders has a first sliding surface configured to be in contact with a respective contact surface of the pressing element and a second sliding surface configured to be in contact with a respective flexible pin of the one or more flexible pins,
wherein the pressing element is movable along a first direction to cause each of the one or more sliders to move along a second direction different from the first direction through a contact between the first sliding surface and the respective contact surface of the pressing element to thereby cause the respective flexible pin to move along the first direction by a movement of the second sliding surface.

2. The device of claim 1, wherein each of the one or more flexible pins comprises:
a contact structure configured to be in contact with a corresponding second sliding surface of a corresponding slider of the one or more sliders;
a flexible structure; and
a connection module configured to move through a mounting hole of a computer hard drive and secure the computer hard drive.

3. The device of claim 2, wherein the contact structure, the flexible structure, and the connection module are integrated into a single piece to form the flexible pin.

4. The device of claim 2, wherein the device further comprises a frame configured to hold the pressing element, the one or more sliders, and the one or more flexible pins.

5. The device of claim 4, wherein the frame comprises:
a top portion comprising a curved portion configured to guide a movement of the pressing element; and
a bottom portion comprising one or more first holes, wherein each of the one or more first holes is configured to guide a movement of a slider of the one or more sliders.

6. The device of claim 5, wherein the pressing element is attached to the bottom portion of the frame through a pressing spring, and wherein the pressing spring is configured to reposition the pressing element along the first direction.

7. The device of claim 5, wherein the bottom portion of the frame further comprises a blocking element configured to limit a range of the movement of the pressing element along the first direction.

8. The device of claim 5, wherein each of the one or more sliders is attached to the bottom portion of the frame through a respective sliding spring, and wherein the respective sliding spring is configured to reposition the slider along the second direction.

9. The device of claim 8, wherein each of the one or more sliders comprises a sliding pin that is surrounded by the sliding spring, the sliding pin being adjacent to the second sliding surface of the slider along a third direction perpendicular to the first direction and the second direction, and
wherein the sliding pin is configured to limit a range of a movement of the slider along the second direction.

10. The device of claim 5, wherein the flexible pin is attached to the bottom portion of the frame through a flexible spring configured to reposition the flexible pin along the first direction,
wherein the flexible pin is configured to move through a hole of the bottom portion of the frame, and
wherein a size of the contact structure of the flexible pin is greater than a size of the hole of the bottom portion of the frame.

11. The device of claim 5, wherein the device further comprises a latch attached to the frame by a rotating pin, and wherein the latch is moveable between an open position and a closed position through a rotation of the rotating pin, and
wherein the latch comprises a blocking module configured to prevent the movement of the pressing element when the latch is at the open position and to let the pressing element move when the latch is at the closed position.

12. A method for assembling a device, comprising:
attaching one or more flexible pins to a frame;
attaching one or more sliders to the frame, wherein each of the one or more sliders is positioned on top of a corresponding flexible pin of the one or more flexible pins; and
attaching a pressing element to the frame,
wherein the pressing element comprises one or more contact surfaces, and each of the one or more sliders has a first sliding surface configured to be in contact with a respective contact surface of the pressing element and a second sliding surface configured to be in contact with a respective flexible pin of the one or more flexible pins, and
wherein the pressing element is movable along a first direction to cause each of the one or more sliders to move along a second direction different from the first direction through a contact between the first sliding surface and the respective contact surface of the pressing element to thereby cause the respective flexible pin to move along the first direction.

13. The method of claim 12, wherein:
the one or more flexible pins are attached to the frame by one or more flexible springs,
the one or more sliders are attached to the frame by one or more sliding springs, and
the pressing element is attached to the frame by a pressing spring.

14. The method of claim 12, further comprising:
attaching a latch to the frame by a rotating pin,
wherein the latch is moveable between an open position and a closed position through a rotation of the rotating pin, and the latch comprises a blocking module configured to prevent a movement of the pressing element when the latch is at the closed position and to let the pressing element move when the latch is at the open position.

15. The method of claim 12, wherein the frame comprises:
a top portion having a curved portion configured to guide a movement of the pressing element, and
a bottom portion comprising one or more first holes each configured to guide a movement of a slider of the one or more sliders,
wherein the one or more flexible pins, the one or more sliders, and the pressing element are attached to the bottom portion of the frame, and
the top portion of the frame is mounted onto the bottom portion of the frame.

16. A method, comprising:
assembling a hard drive assembly onto a computer hard drive;
arranging the hard drive assembly together with the computer hard drive onto a slot of a computing system; and
disassembling the hard drive assembly from the computer hard drive,
wherein the hard drive assembly comprises: one or more flexible pins configured to be insertable into one or more mounting holes of the computer hard drive, a pressing element comprising one or more contact surfaces, and one or more sliders, and wherein each of the one or more sliders has a first sliding surface in contact with a respective contact surface of the pressing element and a second sliding surface in contact with a respective flexible pin of the one or more flexible pins.

17. The method of claim 16, wherein assembling the hard drive assembly onto the computer hard drive comprises:
placing the hard drive assembly onto the computer hard drive, such that each of one or more flexible holes of the hard drive assembly is aligned with a respective mounting hole of one or more mounting holes of the computer hard drive along a first direction; and
pressing the hard drive assembly to cause the respective flexible pin to move through a corresponding flexible hole of the hard drive assembly into a corresponding mounting hole of the computer hard drive along the first direction and at least partially locked in the corresponding mounting hole of the computer hard drive.

18. The method of claim 17, wherein pressing the hard drive assembly to cause the respective flexible pin to move into the corresponding mounting hole of the computer hard drive comprises:
pressing down the pressing element along the first direction to cause each of the one or more sliders to move along a second direction different from the first direction through a contact between the first sliding surface and the respective contact surface of the pressing element to thereby cause the respective flexible pin to move up into a frame of the hard drive assembly through the corresponding flexible hole of the hard drive assembly; and
releasing the pressing element to cause each of the one or more sliders to move along a direction opposite to the second direction to cause the respective flexible pin of the hard drive assembly to move down into the corresponding mounting hole of the computer hard drive along the first direction.

19. The method of claim 16, wherein disassembling the hard drive assembly from the computer hard drive comprises:
pressing the pressing element along a first direction to cause each of the one or
more sliders to move along a second direction different from the first direction through a contact between the first sliding surface and the respective contact surface of the pressing element to thereby cause the respective flexible pin to move out from a corresponding mounting hole of the computer hard drive along the first direction.

20. The method of claim 16, wherein the hard drive assembly comprises a latch configured to prevent a movement of the pressing element when the latch is at an open position and to let the pressing element to move when the latch is at a closed position, and
wherein the method comprises:
moving the latch at the closed position while assembling the hard drive assembly onto the computer hard drive,
moving the latch at the closed position while disassembling the hard drive assembly from the computer hard drive, and
moving the latch at the open position while arranging the hard drive assembly together with the computer hard drive onto the slot of the computing system to prevent the movement of the pressing element.
